(19) United States
(12) Patent Application Publication
(10) Pub. No.: US 2013/0078448 A1
(43) Pub. Date: Mar. 28, 2013

(54) METHOD OF MAKING ELECTROCHEMICAL DEVICE WITH POROUS METAL LAYER

(71) Applicants: Michael C. Tucker, Berkeley, CA (US); Craig P. Jacobson, Moraga, CA (US)

(72) Inventors: Michael C. Tucker, Berkeley, CA (US); Craig P. Jacobson, Moraga, CA (US)

(73) Assignee: THE REGENTS OF THE UNIVERSITY OF CALIFORNIA, Oakland, CA (US)

(21) Appl. No.: 13/637,642

(22) PCT Filed: Apr. 7, 2011
(86) PCT No.: PCT/US11/31578

§ 371 Date: Nov. 28, 2012

Related U.S. Application Data
(60) Provisional application No. 61/322,361, filed on Apr. 9, 2010.

(51) Int. Cl. H01M 8/10

(52) U.S. Cl. CPC H01M 8/10
USPC 428/319.1; 427/180; 156/89.11

(57) ABSTRACT

A method is described for producing layered structures comprising a porous metal layer and a ceramic containing layer comprising wherein a porous green ceramic layer is provided, and thereafter loose metal particles are applied to the green ceramic layer before sintering. In one embodiment, the green ceramic layer, after application of the loose metal particles, is dried to drive off the solvent and cause interpenetration of the metal particles. In another embodiment loose particles can be removed from the composite such as by shaking, and the green ceramic/loose metal particles composite compressed to cause further interpenetration of the metal particles prior to sintering.

### CROSS REFERENCE TO RELATED APPLICATIONS

This PCT application claims priority to Provisional U.S. Patent Application Ser. No. 61/322,361, file Apr. 9, 2010, entitled Method of Making Electrochemical Device with Porous Metal Layer, the contents of which provisional application are incorporated by reference, as if fully set forth herein in its entirety.

### STATEMENT OF GOVERNMENTAL SUPPORT

The invention described and claimed herein was made in part utilizing funds supplied by the U.S. Department of Energy under Contract No. DE-AC02-05CH11231 between the U.S. Department of Energy and the Regents of the University of California for the management and operation of the Lawrence Berkeley National Laboratory. The Government has certain rights in this invention.

### BACKGROUND OF THE INVENTION

1. Field of the Invention

The present invention relates to an improved method for producing layered structures comprising a porous metal layer and a ceramic-containing layer. These layered structures have application in high-temperature electrochemical devices and filtration.

2. Background Prior Art

Most high-temperature electrochemical devices known in the art comprise multiple layers providing mechanical support, electrical current collection, or electrochemical functionality. Adjacent layers generally comprise materials that will join during high-temperature firing by chemical bonding, diffusion bonding, or sintering. This allows multiple particulate layers to be easily assembled in the green state i.e. by laminating, co-extrusion, screen printing, aerosol spraying, etc. Sharp interfaces between the layers are acceptable because the layers will interact in a bonding manner during firing. Strong bonding between the layers is achieved during sintering. For example, a typical Solid Oxide Fuel Cell (SOFC) comprises Ni—YSZ anode, YSZ electrolyte, and LSM (Lanthanum Strontium Manganite)-YSZ cathode. All three layers contain YSZ (Yttria stabilized Zirconia), so sinter-bonding between the layers is achieved during firing.

It is desirable to use porous metal to provide the mechanical support and electrical current collection for high-temperature electrochemical devices. Suitable structures of electrochemical devices comprising porous metal are provided in U.S. Pat. No. 6,605,316. The use of metals reduces material cost while greatly improving strength, as compared to electrochemical devices comprising primarily ceramic or cermet materials. Despite these significant benefits, there is the added challenge of joining the porous metal and electrochemically active layers. Chemical-bonding, diffusion-bonding, and sinter-bonding are generally absent at metal/ceramic interfaces, so bonding between the porous metal and electrochemically active layers relies on mechanical bonding (i.e. through interpenetration of the interface materials, surface roughness, etc. as described in commonly owned and copending U.S. patent application Ser. No. 12/664,646, filed Dec. 13, 2009). Thus, a sharp interface between the porous metal layer and adjacent layer is generally not acceptable. This limits the ease of manufacturing and choice of suitable manufacturing processes.

Many schemes for fabricating electrochemical devices comprising porous metal are known in the art. Typically, a porous metal structure is formed, followed by deposition of the electrochemically active layers on the metal structure, or by joining of the metal structure to the electrochemically active layers. Metal structures are pre-fabricated by etching, perforating, or laser drilling metal preforms, or sintering metal powder, etc. Pre-fabrication of the metal structure adds complexity and expense to the manufacture of electrochemical devices comprising porous metal.

What is thus still needed is a simplified, cost-effective manufacturing route for producing layered structures comprising a porous metal layer and a ceramic containing layer (porous or dense).

### SUMMARY OF THE INVENTION

It is to be understood that throughout this specification “porous” is used to describe a layer which will remain porous after firing and “dense” is used to describe a layer that will be gas-tight after sintering (a dense layer will be porous in the green state or after bisque firing, and only densifies upon sintering). Gas-tight describes a layer of material that has no open path connecting one side of the layer with the other side. Neither a liquid nor a gas-type medium can permeate the layer in normal atmospheric conditions.

In one aspect, this invention relates to a method of fabricating a high-temperature electrochemical device comprising a porous metal layer and a ceramic containing layer. The structure comprises multiple layers of metal, ceramic, or cermet including at least one porous metal layer and at least one porous or dense ceramic-containing layer. The porous metal is intimately bonded to the rest of the structure by interpenetration and mechanical locking. The structure can be quite thin and therefore flexible if it is free-standing. In one embodiment, the structure is symmetric, enabling minimal warping during sintering. The method comprises applying loose metal particles to the adjacent ceramic containing layer of the device before sintering. In this way the metal layer is never free-standing or self-supporting. This allows the fabrication of a very thin and/or very porous metal layer.

A very thin and/or very porous metal layer has processing advantages over thick metal layers. For instance, during co-sintering the shrinkage of the metal and adjacent layers is controlled by the sintering behavior of the ceramic or cermet layers. This is in contrast to related devices with thicker metal layers, for which the sintering is controlled by the metal layer. That situation can cause stress-cracks in the adjacent layers during sintering, in the case that the metal and ceramic/cermet sintering behavior is not well-matched. Furthermore, because the metal need not be free-standing, the need for binder or pore former in the metal layer is reduced or eliminated. This saves the cost of binder/pore former material; eliminates the need for a separate, often slow, debinding step before sintering; and, alleviates the stress associated with debinding which can produce cracks and imperfections in the binder-containing and adjacent layers. This method enables easy, rapid fabrication of the device because the need to preform the metal layer is eliminated. Thus, this method enables low-cost, high throughput fabrication of high-temperature electrochemical devices.

The method of this invention is applicable to planar or tubular embodiments of the device.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 is a process flow chart depicting the various steps of the process of this invention, along with a schematic representation of a composite including a dense ceramic layer adjacent a porous ceramic layer, which in turn is covered with a metal powder layer.

FIG. 2 is a schematic representation showing the application of metal powders to a porous substrate wherein the metal powders are of more than one size, and/or the composite laminate is varied according to another embodiment of the invention.

FIG. 3 is a depiction of a process according to an embodiment of the invention, including a schematic drawing of a device according to the invention at various stages in the manufacturing process.

FIG. 4 is a graph plotting percent linear change vs. temperature for the sintering of TZ3YE, TZ3YE+Y203, and TZ8Y.

FIG. 5 is a cross section of a multilayer electrochemical device made according to the method of this invention disposed between rib and channel interconnects.

FIG. 6 is an illustration of an assembly according to the present invention wherein the multilayer electrochemical device is not flat.

FIG. 7 is a series of photos showing the metal and YSZ surfaces of bilayers, prepared with various drying times between tape-casting and metal sprinkling, according to the process illustrated in Example A.

FIG. 8 is a photo of the polished cross-section of the structure formed in Example B after sintering.

FIG. 9 is a photo of the cross-section of the structure formed in Example E, after sintering.

FIG. 10 is a photo of a cross-section of the structure produced according to Example F, after sintering.

FIG. 11 is a photo of a cross-section of a structure produced according to Example G.

### DETAILED DESCRIPTION

High-temperature electrochemical devices comprising a porous metal layer are typically designed such that the porous metal layer interfaces with an adjacent layer comprising ceramic or cermet, which may in turn contact further adjacent layers. The metal layer may provide a variety of functions including: mechanical support for the device; electrical current collection from the adjacent layer; interconnection between neighboring devices; thermal conduction; and catalysis. The method of this invention provides an improved means of producing such a device comprising a porous metal layer that is well-bonded to the adjacent ceramic or cermet layer. In a general sense, this method comprises applying a loose metal powder to the surface of a pre-formed adjacent green ceramic containing layer. As used herein, the term powder refers to a dry, bulk solid composed of a large number of very fine particles that may flow freely when shaken or tilted. This is in contrast to many techniques known in the art, in which the adjacent layer is applied to a preformed metal layer.

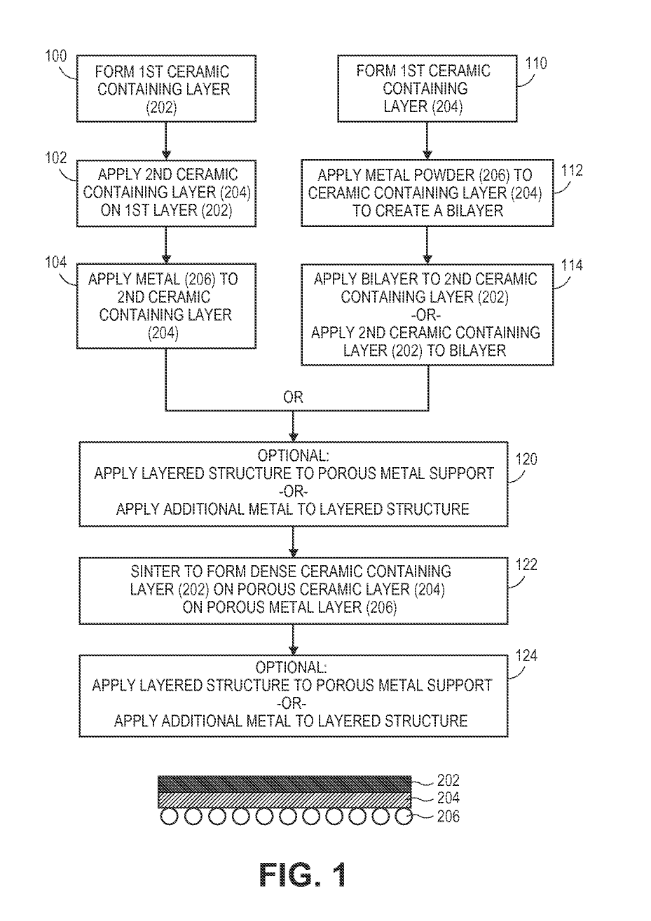

FIG. 1 depicts one embodiment of the method. The object of this embodiment is to provide a structure comprising a dense ceramic containing layer, a porous ceramic containing layer, and a porous metal layer. The dense layer and porous layer are generally ceramic or cermet layers that provide functionality to the device. One specific useful dense layer is an electrolyte, and specific useful porous layers are an electrode, electrode backbone that will accept catalytic material in a later cell fabrication step, or barrier layer that prevents reaction between the metal and other layers. It is to be understood that the invention is not limited to the layers specifically described herein: additional layers not referred herein are within the scope of the invention. While the invention will be described in terms of electrochemical devices it is to be understood that the structures have a variety of applications including filtration of gases or liquids. Filtration requires porous layers and so the dense ceramic containing layer will be omitted.

Multiple process flow paths can utilize the method of this invention. Some of the possibilities are depicted in FIG. 1. It is to be understood that additional steps may be added to this process flow within the scope of this invention. For instance, shaping operations including stamping, rolling, cutting, etc. can be incorporated throughout the process. This process flow is applicable to batch or continuous operation and to tubular or planar devices. The dense layer 202 indicated in steps 100 and 114 may be sintered or green and can be fabricated by many techniques well-known in the art including aerosol spray, tape casting, extrusion, screen printing, powder compaction, dip coating, electrophoretic deposition, plasma spray, etc. It may be desirable to compact the dense layer before further processing in order to increase the green density and handling strength according to US2003021900A1. Suitable techniques include uniaxial pressing, roll calendaring, etc. Likewise, the above techniques may be used to form the porous layer in steps 102 or 110. In step 102, a ceramic containing layer 204 is applied to a dense layer 202 by for instance, pressing, decal transfer, lamination, painting, spraying, screen printing, tape casting, dip coating, etc. These same techniques may be used to join the porous ceramic containing layer 204 and metal layer 206 in step 114.

Much of the advantage of this method is provided by the application of metal to a porous ceramic containing layer 204, in step 104 or 112. The outcome of this step is to contact the surface of the porous ceramic containing layer with loose metal powder, such that some of the metal powder is entrapped by the porous layer creating a mechanical bond.

The metal powder may include pore forming agents or other additives. Many methods of dispersing the metal powder on the surface of the porous ceramic containing layer are acceptable. Preferred methods include: pouring, sprinkling, spraying, gravity fed such as from a hopper, magnetic transfer, entrainment in a high-pressure gas stream (similar to sand-blasting), or contacting the porous layer to a fixed or fluidized bed of metal powder. In order to achieve bonding between the metal and porous ceramic containing layers, generally some interpenetration between the layers is required. This may be achieved by deforming the porous layer around the metal particles, embedding the metal particles in the porous layer, or curing/drying the porous layer after contacting the metal. For example, metal particles may be pushed into the surface of the porous layer by isostatic pressing, roll calendaring, vacuum pressing, uniaxial pressing, etc. This process may be aided by heating the metal, porous layer, or both. The porous layer may also be heated or melted before or after application of the metal, so that the porous layer deforms around the metal and entraps it upon cooling or curing. Alternatively, metal powder may be applied to the porous layer before its surface is dry/solidified from previous processing of the porous layer such as spraying, painting, dip coating, screen printing, etc. Surface tension wicks the porous layer around the metal particles, creating interlocking once the porous layer has dried/solidified completely. At this point in the method, a multilayer structure comprising a green porous ceramic containing layer and green metal powder layer has been fabricated. Excess metal may be removed by shaking, abrading, magnetic pickup, etc., and recycled. The multilayer structure is then sintered in step 122, during which densification of the layers occurs and mechanical interlocking of the metal and porous ceramic containing layer occurs. The sintering step may also include removal of binder, pore former and other additives from the structure by burn-out, solvent extraction, evaporation, melting, etc.

The techniques described above for embedding metal particles in the surface of the porous layer generally transfer a relatively thin layer of metal particles, for instance one to several metal particle diameters thick. For some preferred structural embodiments of this invention, such a thin metal layer is desirable, to reduce bulk or weight, reduce the amount of metal used, allow easy flow through the metal layer, etc. In another embodiment it may be desirable to increase the thickness of the metal layer. This may be done before or after sintering, as in optional steps 120 or 124. For instance a preformed dense or porous metal body may be contacted to the metal of the layered structure. Contact between the metal layer and metal body may be aided by laminating, pressing, magnetic transfer, etc.

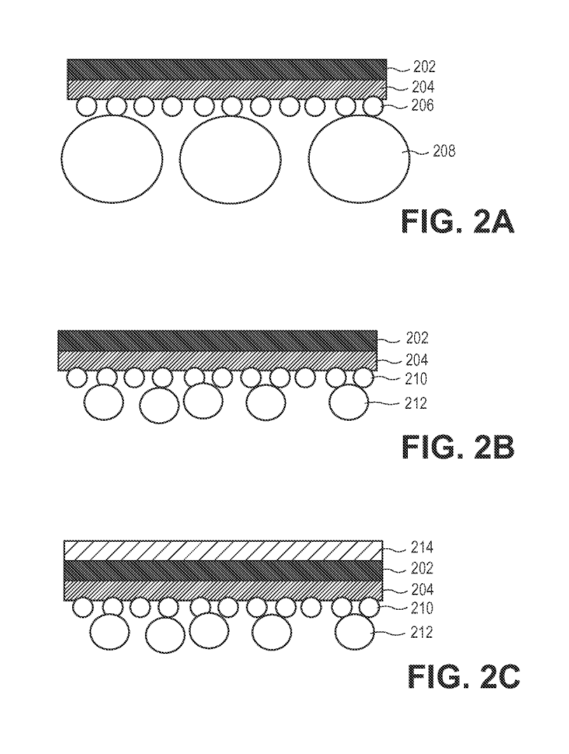

Alternatively, additional uncompacted metal powder may be contacted to the metal that is embedded in the porous layer. Bonding between the metal layer and additional metal powder or preformed metal body can be aided by diffusion bonding, sintering, brazing, welding, etc. The metal embedded in the porous ceramic containing layer and the preformed metal body or additional uncompacted metal powder need not be the same type of metal. They may differ in some or all aspects, including composition, particle size, porosity, shape, surface roughness, etc. The product of this additional embodiment process is depicted in FIG. 2A. The process embeds a monolayer, sub monolayer, or thin layer of rough metal particles 206 in the porous ceramic containing layer 204, and utilizes much larger particles 208 to increase the thickness of the metal layer. As used herein, rough is defined as having an irregular surface as opposed to a smooth surface. The larger particles will have large pores between them, allowing easy gas diffusion. It may be desirable to coat the metal to improve oxidation resistance or reduce Cr volatility. If the larger particles are present as a monolayer or layer only a few particle diameters thick, the entire surface of the porous metal structure is very easy to coat, for instance by aerosol spray, plasma spray, plating, etc.

The product of yet another embodiment is depicted in FIG. 2B. The process embeds a monolayer, sub monolayer, or thin layer of rough particles 210 in the porous ceramic-containing layer 204. The particles 210 can be either metals or oxides that will alloy with metal particles 212 during sintering. The alloying or diffusion bonding process will create a strong bond between the particles 210 and particles 212, and may occur at a lower temperature than that required for sintering either particles 210 or 212. This provides added flexibility to the processing steps. If the particles 210 are oxides, or metals that can withstand oxidation, co-sintering of the dense ceramic layer 202, porous ceramic-containing layer 204 and particles 210 can occur in air. This is an advantage because air sintering is less complex and expensive than reducing atmosphere sintering, and it also allows for the incorporation of materials or additional layers in the structure that are degraded by high-temperature firing in reducing atmosphere. Additional metal particles 212 may then be sintered in a reducing atmosphere at a temperature that is high enough to reduce the particles 210 and cause alloying or diffusion bonding between particles 210 and 212, but not so high as to damage other materials in the structure.

The temperature for diffusion bonding or alloying is generally lower than the temperature that would be required to sinter bond particles 210 or 212. In one embodiment, the particles 210 comprise Cr₂O₃, NiO, or Fe₂O₃. These materials can be sintered at high temperature in air in contact with YSZ without extensive reaction. They can then be bonded to ferritic stainless steel 212 in reducing atmosphere. During this step the oxides 210 are reduced to metals and the metals alloy with the stainless steel 212 to provide diffusion bonding. Because ferritic stainless steel may comprise Cr, Fe, and Ni, the additional amount introduced by alloying with the particles 210 will not substantially affect the properties of the stainless steel layer.

FIG. 2C depicts by way of example a product of this process that includes a Ni-YSZ anode layer 214. Ni-YSZ can be formed by sintering NiO and YSZ in air at 1200-1400° C. followed by reduction of the NiO to Ni at much lower temperature, <1000° C. Alternatively, Ni—YSZ can be formed by sintering in reducing atmosphere at 1200-1400° C., however Ni coarsening in these conditions and poor wetting between YSZ and metallic Ni produce an inferior anode. Therefore it is undesirable to expose the Ni-YSZ anode to the 1200-1400° C. reducing conditions required for sintering ferritic stainless steel. This embodiment avoids that situation by allowing the ferritic stainless steel 212 to be presintered >1200° C. in reducing atmosphere whereas the anode 214, electrolyte 202, porous ceramic 204 and particles (i.e. Cr₂O₃, Fe₂O₃, or NiO) 210 can be co-sintered >1200° C. in air. The presintered ferritic stainless steel can then be joined to the particles 210 by alloying or diffusion bonding in reducing atmosphere at a temperature below that required for sintering ferritic stainless steel, i.e. 1000-1250° C.

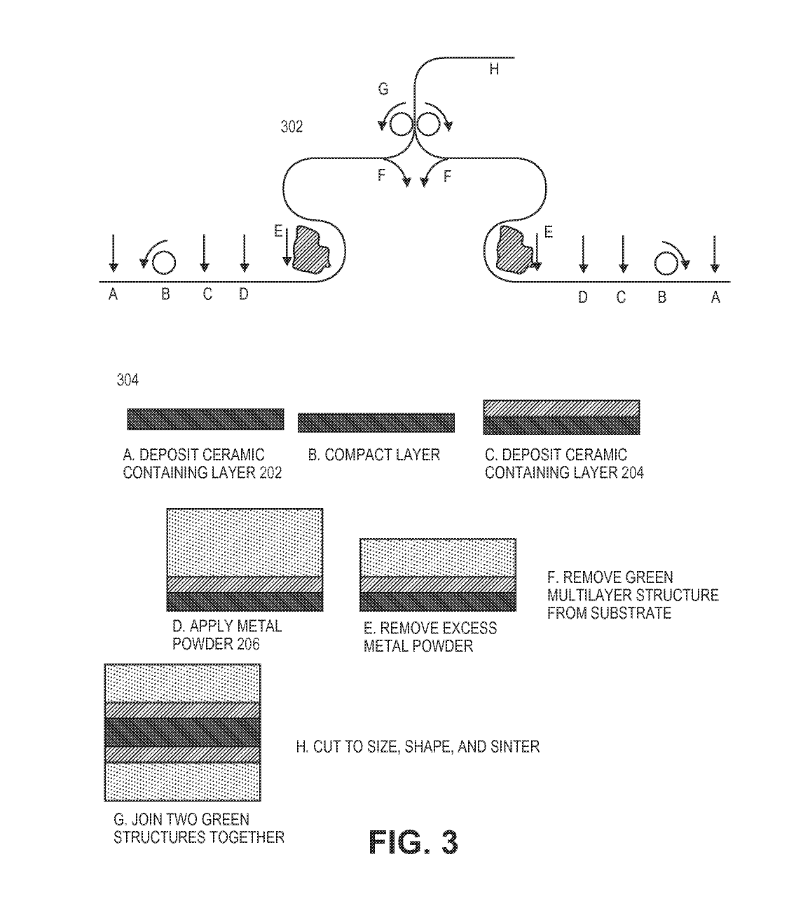

One scheme for continuous manufacturing a high-temperature electrochemical device according to the method of this invention is illustrated in FIG. 3. The top of FIG. 3, 302, illustrates a continuous web substrate (such as Mylar) on which the layers of the device are assembled. The bottom of FIG. 3, 304, illustrates a schematic representation of the device at various process points along the manufacturing line. In this embodiment, two metal layer/porous ceramic layer/dense ceramic layer structures are combined to create the final device structure. The ceramic containing layer 202 is deposited first on the substrate at station (A) and optionally compacted at station (B) to increase green strength or green density. The porous ceramic containing layer 204 is then deposited onto layer 202 at station (C). The metal powder is then deposited onto the porous ceramic containing layer 204 at station (D). Between stations (C) and (D) the porous ceramic containing layer may remain wet or be melted so as to wick onto or adhere to the incoming metal particles. Excess metal powder may then be removed, for example by shaking at station (E).

One particularly easy way to remove the metal is illustrated. The web is turned such that the excess metal falls off by gravity, whereby it may be collected and recycled or directly fall onto the incoming web. Between stations (D) and (E) the metal may be pressed into the porous layer at station (G), for instance by a roll press. The web substrate is then removed, allowing two green multilayer structures to be pressed together such that a sandwich is formed with ceramic containing layer 202 inside and metal layers 206 outside (304, G). Only one of the structures needs to have a dense layer 202, but if both do the likelihood of pinholes and other defects in the final dense layer is minimized because one dense layer will seal over imperfections on the other dense layer.

The two structures need not be the same, but if they are the resulting device is symmetrical. This is desirable because a symmetrical device will experience minimal warping during sintering and the two sides of the device do not need to be differentiated during later processing or assembly. The two structures, joined at station (G) by for instance lamination, roll pressing, etc., then undergo further processing at station (H), such as cutting, shaping, debinding, sintering, etc. One preferred planar device embodiment comprises two multilayer structures sandwiched together in which one of the structures is smaller than the other. This leaves a gap between the perimeters of the two structures. The exposed band of the resulting device is suitable for contacting a sealant, and also prevents unintentional short-circuit contact between the two outside metal surfaces of the device.

One of the main advantages of the method of this invention is that it is inexpensive and straightforward to implement. In keeping with that goal, it is preferred to use binder, pore former, and solvent systems that are in keeping with environmental and human health considerations. This can eliminate the need for expensive and complex solvent recovery or effluent abatement systems. In particular, aqueous solutions for tape casting, dip coating, screen printing, aerosol spraying and similar layer forming steps are preferred. Suitable binders and pore formers include stearic acid, polyethylene glycol, acrylic, polymethyl methacrylate, sodium chloride, hydroxypropylcellulose, and methylcellulose.

It is likewise preferable to use a continuous belt furnace for the high-temperature sintering steps. The use of cost-effective controlled-atmosphere belt furnaces sets an upper limit of about 1225° C. for the sintering steps. In the art, the electrolyte material of choice is 8 mol % yttria-stabilized zirconia (YSZ). Sintering temperatures of 1300° C. or above are typically required to achieve full density for this material, requiring the use of more expensive batch or pusher furnaces. To enable the use of continuous belt furnaces, it is possible to use an electrolyte material that sinters at a lower temperature than 8 mol % YSZ. Preferred compositions include 3 mol % YSZ, 5 mol % YSZ, and 3-10 mol % Scandia-stabilized Zirconia. These materials have the added benefit of being stronger than 8 mol % YSZ, enhancing the mechanical robustness of the thin layers produced by the method of this invention. The 3 mol % YSZ composition is also widely used in multiple industries and is therefore less expensive than the more specialized 8 mol % YSZ composition. However, the low yttria content allows the undesirable formation of monoclinic phases at the grain boundaries of bulk 3 mol % YSZ. Additions of elements such as ceria are known to inhibit this. One embodiment of this invention utilizes low-cost 3 mol % YSZ, mixed with additional yttria powder to eliminate formation of monoclinic phases.

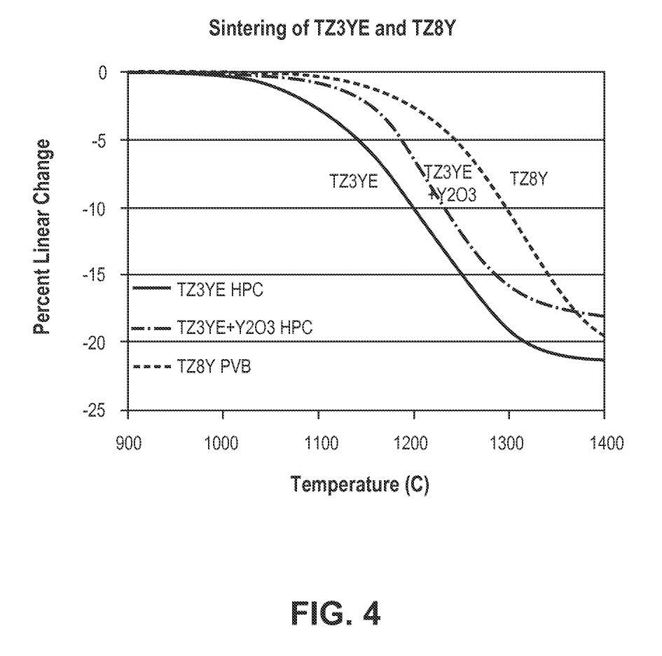

FIG. 4 compares the sintering curves for 8 mol % YSZ (TZ8Y from Tosoh Corporation), 3 mol % YSZ (TZ3YE from Tosoh Corporation) and a mixture of Y₂O₃ and 3 mol % YSZ (8.9:91.1 by weight). The curves were obtained using a dilatometer operating in air and hydroxypropylcellulose (HPC) or polyvinyl butyral (PVB) as binders. Addition of yttria to the 3 mol % YSZ composition delays the sintering by about 40° C. but reduces the sintering temperature by about 75° C. relative to the 8 mol % YSZ. This temperature is in the range attainable by continuous belt furnaces. In addition, modifying the yttria content is a convenient method of matching the electrolyte sintering to that of the porous metal layer, which depends on many factors including particle size, surface morphology, alloy composition, green density, firing protocol, etc. In some embodiments, the method of this invention produces a sub-monolayer of metal particles. In that case, sintering shrinkage of the electrochemical device will be controlled by the electrolyte material, and the electrolyte and metal sintering curves need not be well-matched.

The cubic fully stabilized 8 mol % YSZ displays a considerably higher ionic conductivity than YSZ with lower yttria content (2-6 mol %) that are tetragonal or partially stabilized, making it the preferred electrolyte material. However the greater strength and toughness of the tetragonal and partially stabilized zirconia as well as the lower sintering temperature, lower cost, and high-volume availability of 3 mol % YSZ make it a viable alternative.

Any metal or alloy may be used in the invention with nickel based chromia-forming alloys and iron based chromia-forming alloys being preferred. Of the iron based chromia-forming alloys, ferritic stainless steels are the preferred metal choice for the porous metal layer. This class of stainless steel is inexpensive and displays a good coefficient of thermal expansion match to YSZ. The oxidation behavior of ferritic stainless steels limits the operation temperature of the electrochemical device to less than about 750° C. for long-term stability, with less than about 675° C. preferred.

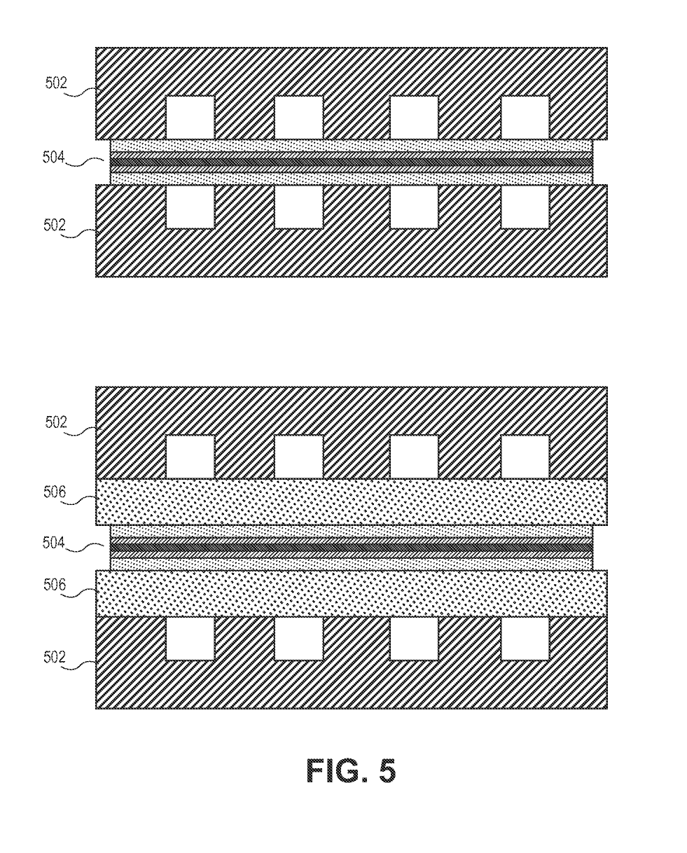

FIG. 5 illustrates an embodiment of the invention in which, after assembly according to the present invention, the multilayer electrochemical device 504 is housed in rib-and-channel flow field or interconnect 502. The ribs of the flow field contact the device, providing electrical connection, whereas the channels provide access for reactant flows. Because the device is thin and flexible, it may be desirable to insert one or more supporting structures 506 between the device and flow field. A porous metal body, metal mesh, expanded metal sheet, or metal felt are preferred supports. These may be joined to the device or to the flow field, or may simply be held in place by compression. Multiple device/flow field units can be assembled to provide a stack.

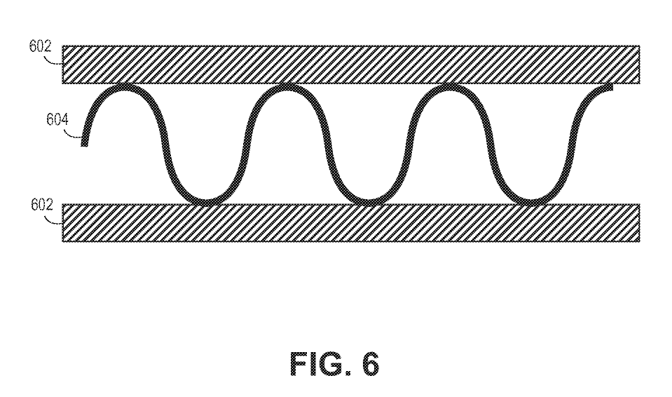

FIG. 6 illustrates an embodiment in which, after assembly according to the present invention, the multilayer electrochemical device is not flat. The device 604 may be shaped by corrugation, dimpling, etc. The device is thin and flexible both in the green state and after sintering, so the shaping may occur before or after sintering. In the case of corrugation, as depicted, and similar shapes, gas flow channels are naturally created by inserting the device between interconnects or housings 602. The device may be joined to the housing by various methods including brazing, welding, and diffusion bonding. One advantage of this design is that the device and housing need not be well-matched in coefficient of thermal expansion. If the flow field of FIG. 5 expands more than the device, it will hold the device in tension possibly leading to cracking of the dense layer. In contrast, the corrugated device of FIG. 6 can expand and contract with respect to the housing without putting the device in tension. Multiple device/housing units can be assembled to provide a stack.

### EXAMPLES

In the following examples, “YSZ” is Tosoh TZ8Y yttria-stabilized zirconia, “NiO” is green nickel oxide (J.T. Baker), and “metal” is water-atomized 434 stainless steel powder (25-75 μm).

The examples set forth here are intended to illustrate some of the aspects of this invention and in no way limit the scope or applicability of the invention. In particular, the method of the invention is illustrated below by producing layered structures comprising YSZ and stainless steel. The invention is not limited to these compositions, but rather can be practiced using any ceramic, cermet, or metal compositions.

### Example A

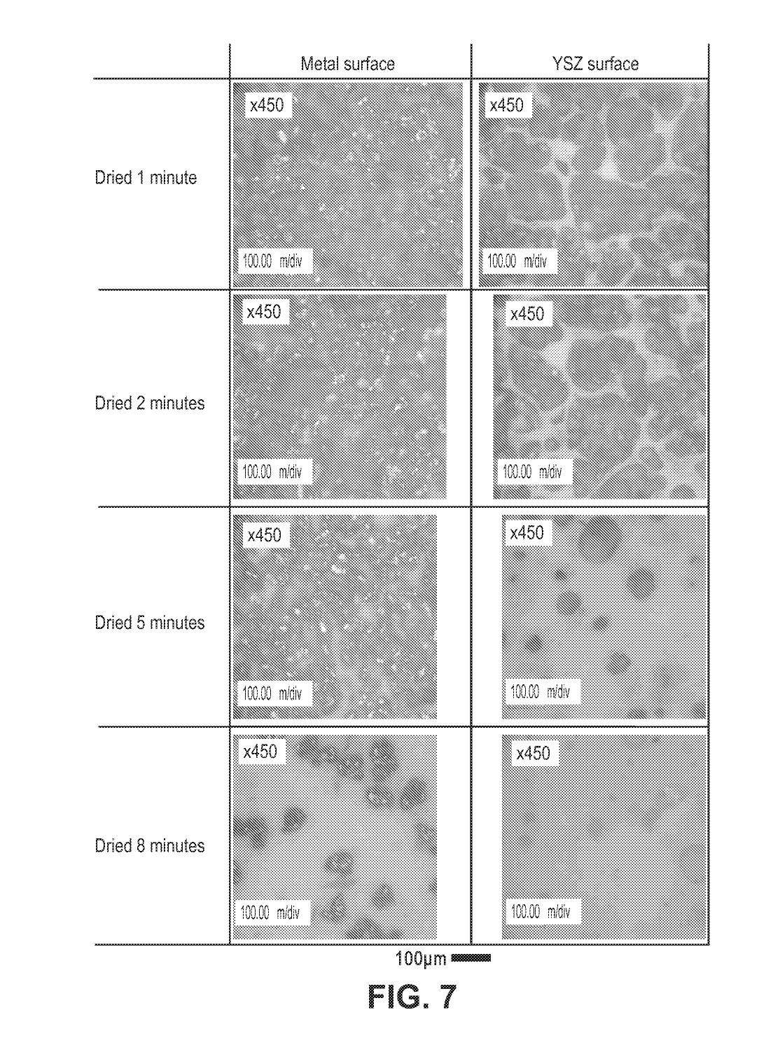

Tape-cast sheets of porous YSZ were prepared by casting a viscous slurry of acrylic-YSZ (0.96 g acrylic solution [42 wt % in water], 0.54 g YSZ, 0.08 g Acrylic 0.5-10 μm pore former beads) onto a mylar sheet substrate. The slurry was allowed to air-dry for a set amount of time with no heat applied. After the drying time, metal powder was sprinkled over the tape-cast porous YSZ sheet. A thick layer of metal powder was applied in this way, followed by further drying of the slurry. After drying, excess metal was shaken off, leaving behind a layer of uncompacted metal powder adhering to the porous YSZ sheet. Thus a porous YSZ-metal powder bilayer was formed. FIG. 7 shows the metal and YSZ surfaces of such bilayers, prepared with various drying times between tape-casting and metal sprinkling. The results for various drying times are discussed below.

1 minute, 2 minutes: The tape-cast YSZ slurry was very wet and capillary forces wicked most of the slurry into the uncompacted metal powder layer. This caused a relatively thick layer of metal powder to adhere. The adherent metal powder layer is loosely packed and quite porous.

5 minutes: The tape-cast YSZ slurry dried enough to prevent excessive wicking into the metal layer. Adhesion of the metal particles was still very good, but a thinner layer of metal particles adhered. Some bubbles introduced during tape-casting are visible in the porous YSZ layer. Metal powder did not penetrate completely though the YSZ layer.

8 minutes: Limited adhesion of metal powder to nearly-dry tape-cast YSZ slurry resulted in less than a monolayer of adherent metal particles. Note that sub-monolayer coverage by metal powder is not generally possible with other techniques known in the art.

10 minutes: The surface of the tape-cast layer was dry to the touch, resulting in minimal adhesion of metal particles. The metal particles that did adhere were easily brushed off by hand.

In all of the above cases, the metal-YSZ bilayers were allowed to dry about 15 minutes from the time of tape casting before removing the Mylar substrate. Although dry, the YSZ layer was still tacky at this time; pressing two bilayers together with the YSZ surfaces touching resulted in bonding with even minimal pressure applied by hand. After drying overnight the layers were no longer tacky, and bonding between two bilayers required significant pressure applied by hydraulic press.

### Example B

Tape-cast sheets of porous YSZ were prepared by casting a viscous slurry of acrylic-YSZ (0.96 g acrylic solution [42 wt % in water], 0.54 g YSZ, 0.08 g Acrylic 0.5-10 μm pore former beads) onto a mylar sheet substrate, drying, and peeling off the mylar sheet. Two layers of the resulting acrylic-YSZ tape were uniaxially pressed (10 kpsi) on either side of a tape-cast sheet of dense YSZ (Electro-Science Laboratories, Inc.) forming a porous/dense/porous YSZ structure. These YSZ layers were then sandwiched between metal-porous YSZ bilayers prepared according to Example A (with 5 minutes drying time before application of the metal) with the porous YSZ layers of the porous/dense/porous structure and metal-YSZ bilayers adjacent. This sandwich was then uniaxially pressed (1 kpsi) to bond all the acrylic-containing layers together. The structure was then debinded in air at 525° C. to remove the acrylic binder and pore former beads, followed by sintering in reducing atmosphere (4% H₂-96% Argon) at 1300° C. for 4 h.

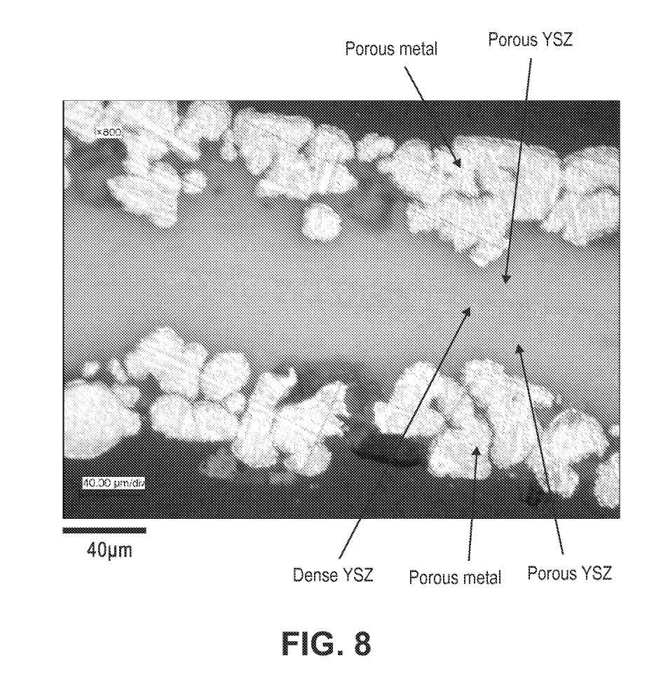

The sintered structure was somewhat flexible and required modest effort to fracture. FIG. 8 shows the polished cross-section of this structure after sintering. The entire structure is only 300 μm thick. Excellent bonding exists at the metal/porous YSZ interfaces and porous YSZ/dense YSZ interfaces.

### Example C

A Mylar sheet substrate was brush-painted with 20 thin coats of acrylic-YSZ paint (2.7 g acrylic solution [15 wt % in water], 0.54 g YSZ, 0.08 g Acrylic 0.5-10 μm pore former beads). Each coat was dried between applications, using a heat lamp to speed the drying. A final coat was applied and left wet. Metal powder was then sprinkled onto the wet surface, forming a loose-packed layer much thicker than the diameter of a single metal particle. A heat lamp was then used to dry the acrylic-YSZ paint. The excess metal powder was shaken off, leaving behind a layer of porous metal a few particle diameters thick. This metal was well-bonded to the acrylic-YSZ layers. The metal/acrylic-YSZ bilayer was easily peeled from the mylar substrate, producing a structure with good handling strength, a rough porous metal surface, and a very smooth and uniform acrylic-YSZ surface.

### Example D

A Mylar sheet was painted with 20 coats of acrylic-YSZ as described in Example C. The last coat was dried completely. Metal powder was sprinkled onto the acrylic-YSZ surface and uniaxially pressed in at 500 psi. The metal powder adhered well to the surface of the acrylic-YSZ layer.

### Example E

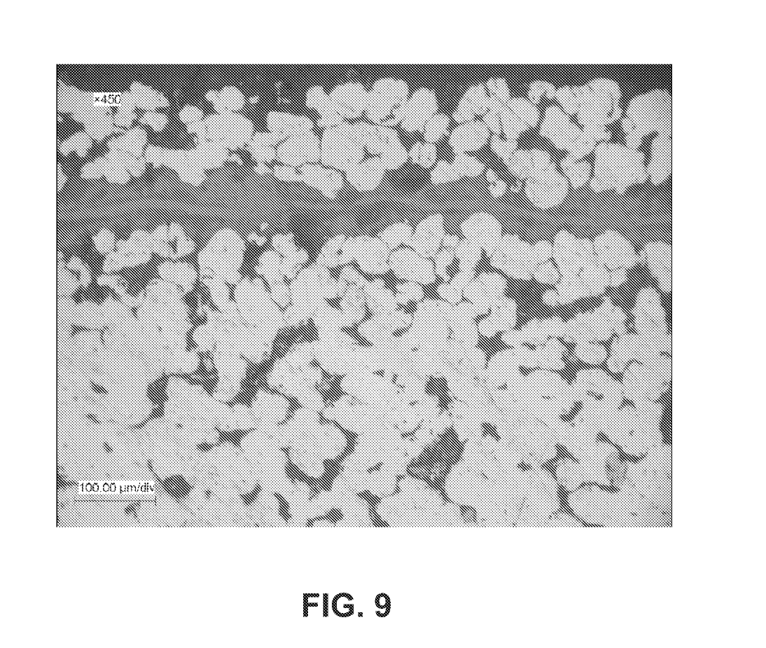

A tape-cast sheet of dense YSZ (Electro-Science Laboratories, Inc.) was uniaxially pressed at 10 kpsi to increase handling strength and green density. This was then sandwiched between the porous acrylic YSZ tapes described in Example A. Tapes dried 10 minutes (no metal adhered) were applied directly contacting both sides of the dense YSZ layer. Tapes dried 2 minutes before metal addition were applied adjacent these layers, with the metal side facing out. This entire structure was then uniaxially pressed at 1 kpsi to bond the layers together. The layered structure was then placed on an alumina plate. Additional metal powder was sprinkled on top of the structure in order to form a thicker, stronger metal layer on one side of the structure. After sintering in reducing atmosphere at 1300° C. for 4 h, the layers were well bonded. A cross-section image of the structure is shown in FIG. 9. The thicker metal layer is visible at the bottom of the image; the porous/dense/porous YSZ layers and thinner metal layer are visible at the top.

### Example F

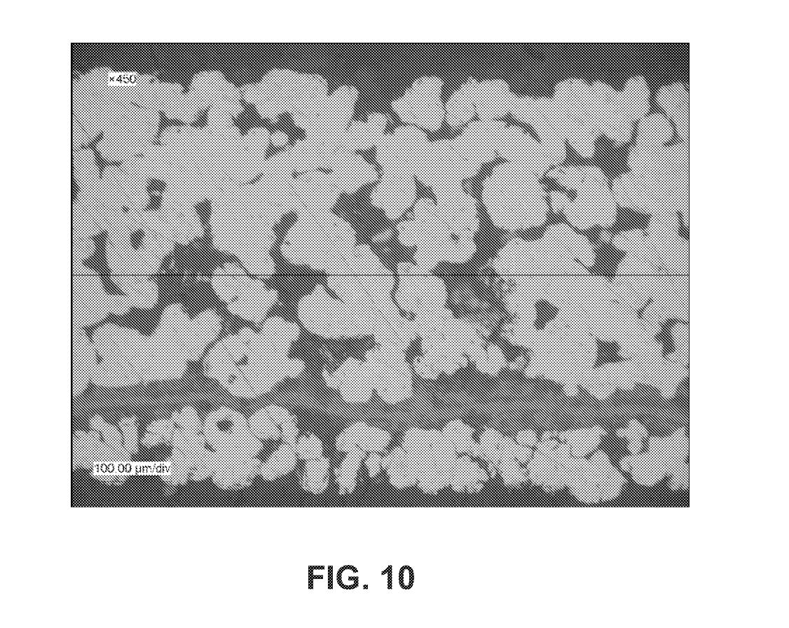

A porous metal/porous YSZ/dense YSZ/porous YSZ structure/porous metal composite was prepared by uniaxially pressing (1 kpsi) the layers together. The first porous metal and porous YSZ bilayer was prepared as described in Example A with 5 minutes drying time between casting and application of metal. The dense YSZ layer was a tape-cast sheet (Electro-Science Laboratories, Inc.). The adjacent porous YSZ layer was prepared as described in Example A with 10 minutes drying time (no metal adhered). These layers were assembled and then pressed onto a bisque-fired porous sheet of ferritic stainless steel powder. The resulting structure was then debinded in air at 525° C. and sintered in reducing atmosphere at 1300° C. for 4 h. The layers were well bonded after sintering. A cross-section image of the structure is shown in FIG. 10.

### Example G

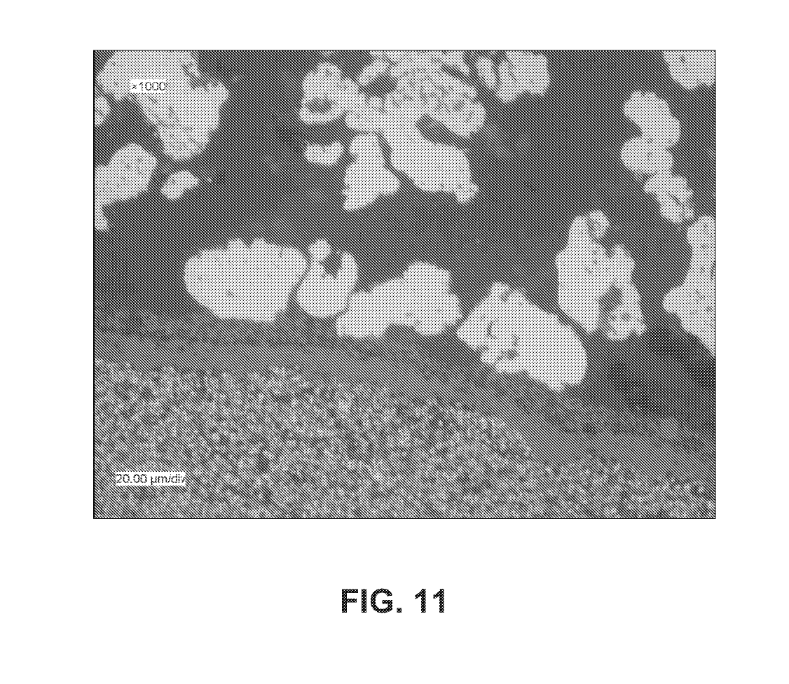

A tubular SOFC element consisting of NiO-YSZ support and thin YSZ electrolyte layer was prepared by sintering in air at 1400° C. for 4 h. A porous layer of YSZ was then applied by painting 20 coats of the acrylic-YSZ paint indicated in Example C, drying each coat between applications. A final coat of paint was then applied and left wet. Metal powder was sprinkled onto the wet paint and the resulting structure was dried under a heat lamp. The cell was then fired in reducing atmosphere (4% H₂-96% Ar) at 1275° C. for 2 h. After firing, the metal powder was well-bonded to the porous YSZ layer and highly electronically conductive indicating good metal-metal necking A cross-section image of the cell is shown in FIG. 11. The metal is very porous, and the particles that touch the porous YSZ surface are well bonded to it.

### Counter-Example A

A porous/dense/porous YSZ structure comprising no metal was fabricated using the same techniques to the above examples. Dried, tape-cast layers of porous acrylic-YSZ were laminated on either side of a tape-cast sheet of dense YSZ (Electro-Science Laboratories, Inc.) by uniaxially pressing (1 kpsi). The structure was then debinded in air at 525° C. to remove the acrylic binder and pore former beads, followed by sintering in reducing atmosphere (4% H2-96% Argon) at 1300° C. for 4 h.

The resulting structure was so weak that picking it up without fracturing it was difficult. Clearly, the addition of porous metal powder well-bonded to the YSZ layers by the methods of this invention imparts greatly improved strength and flexibility to the resulting structure.

It can be seen from the above Detailed Description of the invention that a highly manufacturable method is provided for producing a high-temperature electrochemical device comprising a porous metal layer and a ceramic containing layer. The resulting structure features good bonding between the metal layer and adjacent layer, and is thin, flexible, and lightweight. One key aspect of the method is that at least one of the metal layers is never free-standing. This allows the use of uncompacted metal powder with minimal binder and pore former and reduces complexity of the manufacturing process.

Although the foregoing invention has been described in some detail for purposes of clarity of understanding, it will be apparent that certain changes and modifications may be practiced within the scope of the appended claims. In particular, while the invention is primarily described with reference to porous ferritic steel and YSZ layers in solid oxide fuel cells, other material combinations which would be readily apparent to those of skill in the art given the disclosure herein, may be used in SOFCs or other electrochemical devices, such as oxygen generators, electrolyzers, or electrochemical flow reactors, etc., in accordance with the present invention. It should be noted that there are many alternative ways of implementing the processes of the present invention. Accordingly, the present embodiments are to be considered as illustrative and not restrictive, and the invention is not to be limited to the details given herein.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

We claim:

1. A method for producing layered structures comprising a porous metal layer and a ceramic containing layer comprising:
providing a green ceramic layer, and thereafter,
applying loose metal particles to said ceramic layer.

2. The method of claim 1 wherein the metal particles are in the form of a dry powder.

3. The method of claim 1 wherein the metal particles are rough particles.

4. The method of claim 1 where the green ceramic layer is a porous layer.

5. The method of claim 4 including a further processing step applied to the loose metal particles and the porous green ceramic layer such as to cause interpenetration and mechanical locking of the particles within the ceramic layer.

6. The method of claim 5 comprising the firing of the combined green ceramic layer and the metal particles.

7. The method of claim 1 wherein the metal particles are applied to said green ceramic layer by pouring, sprinkling, spraying, hopper feeding, magnetic transfer, entrainment in a high-pressure gas stream, or contacting the porous layer to a fixed or fluidized bed of metal powder.

8. The method of claim 4 wherein the green ceramic layer is allowed to partially dry for a period of time but remains wet before the application of the loose metal particles.

9. The method of claim 8 wherein the green ceramic layer is dried for a period of time, and then additionally wet painted, sprayed, dip coated, screen printed, and the like before application of the loose metal particles

10. The method of claim 5 wherein the further processing step comprises the drying of the porous green ceramic layer for a period of time after application of the loose metal particles, whereby surface tension wicks the porous layer around the metal particles, creating interlocking interpenetration once the porous layer has dried/solidified completely.

11. The method of claim 5 wherein the further processing step includes a compression step for imbedding the metal particles into the porous layer, said compression step selected from one or more of the methods comprising isostatic pressing, uniaxial pressing, roll calendaring, and vacuum pressing.

12. The method of claim 11 wherein the metal, the porous layer or both are heated during the compression step.

13. The method of claim 5 wherein interpenetration of said metal particles into the green ceramic is enhanced by deforming the porous layer around the metal particles.

14. The method of claim 1 wherein excess metal particles are removed from the layered structure prior to further processing.

15. The method of claim 1 wherein the metal of the metal particles is selected from the group comprising Fe, Cr, Ni, Cu, FeCr, NiCr, ferritic stainless steel, mixtures and alloys thereof, and oxides thereof.

16. The method of claim 12 wherein the ceramic is selected from the group comprising yttria-stabilized zirconia, calcia-stabilized zirconia, and scandia-stabilized zirconia.

17. The method of claim 1 in which after said loose layer of metal particles are first applied to the ceramic layer, larger sized metal particle are then applied to increase the thickness of the metal layer.

18. The method of claim 1 in which after said loose layer of metal particles are first applied to the ceramic layer, particles of metals or oxides are applied that alloy with the first layer of metal particles during sintering.

19. A layered composite material produced by the method of claim 1.

20. The layered composite material of claim 19 wherein the porous metal layer is a thin metal layer of from one to several metal particle diameter thicknesses.

21. The composite material formed according to the method of claim 10 further including a dense ceramic layer adjacent the one surface of the porous ceramic material, the loose metal particle layer adjacent the opposite surface of the porous ceramic material.

22. A continuous method for forming a porous metal layer atop a porous ceramic layer composite comprising the steps of:
providing a continuous web substrate upon which various layers are to be assembled, which substrate can be moved from one processing station to another along a continuous belt;
moving said web substrate to a first station for deposition of a porous green ceramic layer;
moving said green ceramic layer/web substrate to a second station for deposition of a loose metal powder onto the porous green ceramic layer, the porous green ceramic layer still wet at the time of deposition of the metal particles, so as to wick and adhere the incoming metal particles;
moving the ceramic/metal particles composite to a third station where excess metal powder removed;
moving the resulting ceramic/metal composites to a forth station where the continuous web substrate is separated from the composite ceramic/metal particle layer; and thereafter,
sintering the composite material.

23. The continuous method of forming a porous metal layer containing composite according to the method of claim 22 further including the steps of:
depositing a first ceramic containing layer onto the continuous web, and thereafter compacting it to increase its green density prior to deposition of said first porous green ceramic layer.

24. The continuous method of claim 22 in which a second continuous web substrate is provided upon which various layers are to be assembled, which second continuous web substrate can be moved in a direction opposite from the direction of said first continuous belt; the method further including the steps of:
moving said second continuous substrate from one station to another to first deposit a porous green ceramic layer upon said substrate, followed by the deposit of loose metal particles upon said porous green ceramic layer, said layer still wet at the time of deposition, so as to wick and adhere the incoming metal particles, and thus form a second ceramic/metal particle composite, removing excess metal particles, separating the second continuous web from the second ceramic/metal particle composite thus formed; and thereafter,
bringing said first and second ceramic/metal particle composite layers together to form a composite in which the metal particles are to the outside of the composite and the green ceramic substrates are joined to form a ceramic containing layer inside the metal layers.

25. The continuous method of claim 24 wherein the first and second ceramic/metal particle composite layers are brought together in a lamination roll.

26. The method of claim 24 wherein a green ceramic layer is first deposited on each of said first and second continuous web substrates prior to the deposition of said porous green ceramic layers, said first deposited layer compressed to form a densified green ceramic layer, such that when the two composites layers are brought together, the combined composite comprises an inner layer of densified green ceramic, followed by a layer of a porous green ceramic on each side of said densified layer, followed by metal particle layers disposed on the outside of the composite ceramic layers.
